(19) United States
(12) Patent Application Publication
(10) Pub. No.: US 2001/0044750 A1
(43) Pub. Date: Nov. 22, 2001

(54) Method for directing consumers to preferred coffee selection

(75) Inventors: Robert David Piotrowski, Hamilton, OH (US); Molly Christine Findley, Cincinnati, OH (US); Caryn Marie Crawford, Fairfield, OH (US); Michelle Carolyn Faber, West Chester, OH (US)

Correspondence Address: Erich D. Hemm, The Procter & Gamble Co., 6071 Center Hill Avenue, Cincinnati, OH, 45224, US

(73) Assignee: The Procter & Gamble Co.

(21) Appl. No.: 09/804,819

(22) Filed: Mar. 13, 2001

Related U.S. Application Data
(60) Provisional application No. 60/188,956, filed on Mar. 13, 2000.

(51) Int. Cl. G06F 17/60

(52) U.S. Cl. 705/26

(57) ABSTRACT

The present invention is an effective method for directing coffee consumers to one or more types of coffee from a plurality of options by a consumer.

### CROSS REFERENCE TO RELATED APPLICATION

This application claims the benefit of priority to U.S. Provisional Application Serial No. 60/188,956, filed Mar. 13, 2000, which is herein incorporated by reference.

### FIELD OF THE INVENTION

The present invention is related to a method for directing consumers to their preferred type of coffee utilizing simple self-characterization cues that are easily recognizable by the consumer. More particularly, the present invention is directed to a method in which there is utilized a communication (e.g. charts, guides, symbols, phrases, or other communication) via a representation (e.g., coffee package, bin card, or other representation) at the point of purchase that helps the consumer to characterize the coffee and purchase a preferred coffee for himself.

Use of the method to direct the consumer based on the consumer's own self-characterization of their individual tastes and preferences results in significantly higher satisfaction with the product than if these products were self-selected by the consumer without the self-characterization indicators from the same available options.

### BACKGROUND OF THE INVENTION

A wide variety of coffee products are currently available in the market place. As used herein, a “coffee product” is a particular type of whole bean, ground, instant or formulated coffee beverage which may be prepared by the consumer or purchased in a ready-to-drink form. In recent years, the variety of coffee products available in the marketplace has grown. There are multiple products at different degrees of roast, different grinds, and different coffee blends utilizing beans of different origin.

Understanding coffee for the consumer has gotten extremely complex, and rivals the exercise of understanding wines; given that there are different types of grapes, each having flavor notes and characters that can be impacted by year to year changes in soil conditions and climate, with there being the possibility that all these be blended in different ways and fermented for various time periods and under different conditions. At the same time, many consumers want to be able to choose the right coffee for themselves quickly and reliably with minimal effort, preferably the first time, and every time. Further complicating this situation is that in a given store, literally dozens of options with respect to coffee products might be available for purchase. Accordingly, there is a need to have the capability of quickly and simply directing the consumer to a coffee or coffees that will meet his individual preferences among the myriad of choices.

All this has been exacerbated by the fact that many consumers do not understand how the various options available with respect to coffee products correspond to their taste preferences. It is generally accepted that consumers instinctively know what type of coffee they like when they taste it, but it is an immense challenge for the coffee manufacturer to help the consumer select the right coffee since the consumer himself lacks the language to communicate his preferences. The challenge is increased by the fact that the common consumer does not want to spend much time figuring out which coffee they will like, and thus it is necessary to communicate with the consumer using self-apparent, almost intuitive cues.

A consumer's level of satisfaction with a product is described as the product's “acceptance.” Whether or not a given consumer will “accept” a given coffee product is a matter of taste which is, of course, subjective. Nevertheless, it can be demonstrated empirically that each person has a stated taste preference which may be identified and used to predict acceptance of a given coffee product among those with similar stated flavor preference. Additionally, the degree of such acceptance among consumers with the same flavor preference may be quantified using statistical methods.

It is, therefore, desirable to provide a method which will allow a consumer to quickly and reliably identify one or more coffee products which that consumer has a statistically greater chance of accepting from a taste preference standpoint than other available coffee products. Ideally, such a system should be quick and simple to understand and use while providing the maximum advantages of preference matching.

### SUMMARY OF THE INVENTION

The present invention is an effective method for directing coffee consumers to one or more types of coffee from a plurality of options by a consumer.

We have discovered that there are two key aspects to coffee flavor which together successfully predict how much a consumer will like a given type of coffee: (1) degree of roast and (2) flavor character. Through the effective use of words and other cues described herein, consumers can communicate or select their desired degree of roast with relatively high success. However, we find that a common language to describe flavor character is lacking. For instance, the term ‘acidity’, a coffee attribute often considered desirable by coffee experts, has negative connotations in the minds of many consumers. Some of these consumers truly dislike acidic coffee, but many of these consumers prefer acidic coffee and are not aware of it. All these things come together to make it very difficult to communicate a coffee's flavor to the consumer such that he can easily identify a coffee that matches his preferences.

The present invention, in one preferred embodiment, is directed to a method wherein a consumer is presented with multiple self-characterization cues that allow the consumer to characterize his desired coffee in a way the consumer readily understands and is familiar with. These cues will be readily understandable to large numbers of consumers, and more importantly, will have substantially identical meanings to various individuals. The coffee flavor is communicated to the consumer through the use of two or more characterization cues. The cues can be divided into three types as defined herein:

(1) Objective Cues—the term “Objective Cues” as used herein are those cues which provide informative, coffee-related data. These may include, for example, a roast scale to identify the degree of roast or a coffee guide which utilizes concise descriptions of the coffee flavor delivered by each classification. Other Objective Cues could include, but are not limited to, coffee information addressing characters of different narrative coffee bean varietals, different roasting methods, and/or different grinding techniques.

(2) Abstract Lifestyle/Personality Cues—the term “Abstract Lifestyle/Personality Cues” as used herein are those cues which utilize depictions of physical objects or props to ascribe a “personality” or “character” to the coffee, thus intuitively aiding the consumer in understanding the coffee's flavor character. Objects and props may include Coffee Related Accessories and Non-Coffee Related Objects and Props, as defined herein. The Abstract Lifestyle/Personality cue may include the following:

(a) an Object or Prop which remains constant across all classifications but varies in shape or style across three or more classifications (e.g. a cup/mug which varies in shape or style)

(b) a Non-Coffee Related Object or Prop which is unique across three or more classifications (e.g. a vase used to represent one classification, a violin used to represent a second classification, and a suitcase used to represent a 3rd classification)

(3) Physical Cues—the term “Physical Cues” as used herein refers to all other cues which most commonly include, but are not limited to, the use of color, lettering style, texture, icons, shape, and/or names which utilize an adjective commonly used to describe a personality. When bundled with Objective Cues or Abstract Lifestyle/Personality Cues, Physical Cues can enhance the communication. They also play a key role in the consumer's repeated recognition of a particular classification at purchase decisions subsequent to the first purchase decision.

The self-characterization cues allow the consumer to readily identify the coffee type or types most likely to be preferred by the consumer and thereby allows the consumer to identify and purchase one or more of said products, as well to remember and re-identify the coffee product at the point of subsequent purchases.

### Definitions

Object or Prop: As used herein, an “Object or Prop” used as an Abstract Lifestyle/Personality Cue is one that is commonly recognized as being found in a household or office environment, or other location where coffee is made, sold or consumed, such as a store, school, or airport, such as a table, chair, piano, vase, or suitcase, or one that is recognized as a personal effect such as clothing, jewelry, makeup, briefcase, wallet, keys, or scarf.

Non-Coffee Related Object or Prop: As used herein, a “Non-Coffee Related Object or Prop” is an Object or Prop that is not utilized in the production, preparation, or consumption of coffee beverages.

Coffee-Related Accessory: As used herein, a coffee-related Accessory is one recognized as being used in the production, preparation, or consumption of coffee beverages (e.g. a coffee plant, coffee beans, sacks or drums of beans, coffee brewer, scoops, sugar, sugar bowl, cream, cream pitcher, cup or mug).

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 is an Objective Cue, specifically a roast scale, which indicates the degree of roast for a product or products which fall within a particular classification. Three roast scales are shown, each of which may be used at the point of purchase to help characterize three unique classifications. Each roast scale indicates a different degree of roast using an icon to depict the position on the scale. The varying color of the sun icon is a Physical Cue.

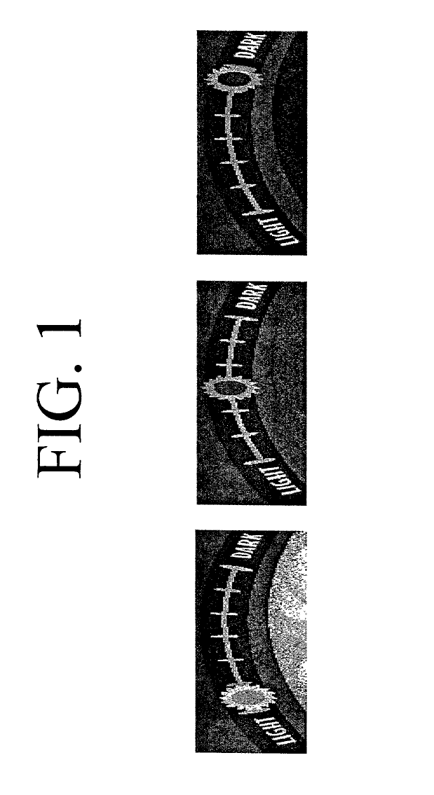

FIG. 2 shows a coffee guide, an Objective Cue which utilizes words to describe both the degree of roast and flavor character for each of six classifications. The use of colored banners and suns as Physical Cues are also incorporated into the coffee guide. When used on the package, the classification contained in the package is identified via a unique banner, shown below for the Daring classification. Otherwise, the coffee guide remains identical across all the classifications. The coffee guide provides information on all the varieties to the consumer to allow for easy comparison across all the varieties.

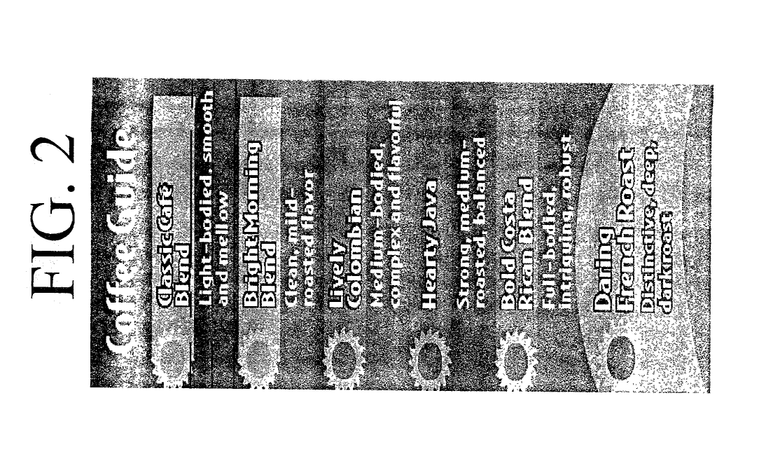

FIG. 3 depicts an example of an Abstract Lifestyle/Personality Cue. The sun icon, a Non-Coffee Related Object or Prop, which varies in shape to provide a distinctive representation across two or more classifications, is used to ascribe a ‘personality’ to each coffee classification. The suns also vary in color, bundling a Physical Cue in with the lifestyle/personality cue.

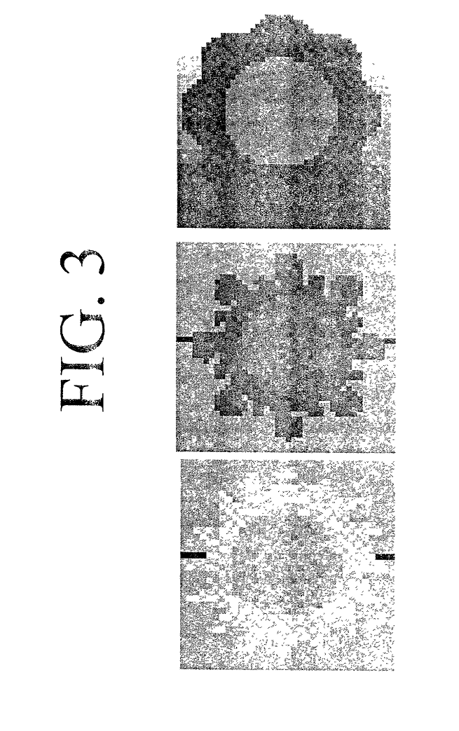

FIG. 4 depicts another example of an Abstract Lifestyle/Personality Cue. A different style or shape of cup or mug is used to ascribe a personality to each coffee classification. The cup is a Coffee-Related Accessory. The cups also vary in color, again bundling a Physical Cue in with the lifestyle/personality cue.

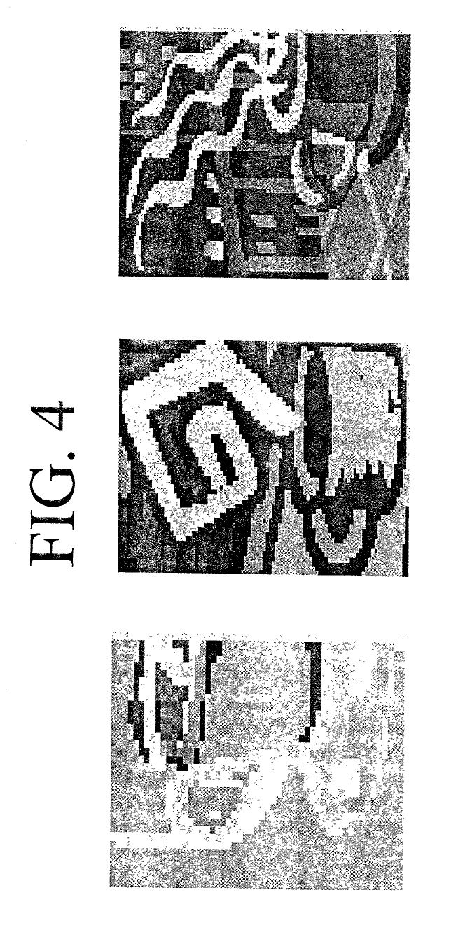

### DETAILED DESCRIPTION OF THE INVENTION

The present invention is directed to an effective method for directing coffee consumers to one or more types of coffee from a plurality of options by a consumer.

The coffee is part of a lineup of coffees under a common brand name and package type, wherein the coffees can be described via two or more vectors. These vectors are most preferably degree of roast and flavor character.

When the appropriate cues are used, degree of roast is relatively well-understood by the consumer. Thus, the first vector, degree of roast, can be effectively communicated via objective, coffee-related information. However, flavor character is a more difficult concept for the consumer to grasp, particularly because there is no common language for flavor character among consumers. The complexity of communicating the second vector requires the use of multiple cues or signals at the point of purchase, some of which are non-objective, in order to effectively communicate with the consumer. These cues are all bundled to direct a consumer to a particular classification of coffee products from a group of two or more available classifications.

Through careful selection of the type and nature of the cues, consumers are able to simply and quickly gravitate towards a coffee that will, in fact, match their individual preferences.

The present invention, in one preferred embodiment, is directed to a method wherein a consumer is presented with multiple cues that allow the consumer to characterize his desired coffee in a way the consumer readily understands and is familiar with. These cues will be readily understandable to large numbers of consumers, and more importantly, will have substantially identical meanings to various individuals. The self-characterization cues are communicated to the consumer through the use of two or more self-characterization cues. The cues can be divided into three types as defined herein:

(1) Objective Cues—cues which provide informative, coffee-related data. These may include a roast scale to identify the degree of roast or a coffee guide which utilizes concise descriptions of the coffee flavor provided by each classification.

(2) Abstract Lifestyle/Personality Cues—the term “Abstract Lifestyle/Personality Cues” as used herein are those cues which utilize depictions of physical objects or props to ascribe a “personality” or “character” to the coffee, thus intuitively aiding the consumer in understanding the coffee's flavor character. Objects and Props may include Coffee Related Accessories and Non-Coffee Related Objects and Props, as defined herein. The Abstract Lifestyle/Personality cue may include the following:

(a) an Object or Prop which remains constant across all classifications but varies in shape or style across three or more classifications (e.g. a cup/mug which varies in shape or style)

(b) a Non-Coffee Related Object or Prop which varies in nature across three or more classifications (e.g. a vase used to represent one classification, a violin used to represent a second classification, and a suitcase used to represent a third classification)

(1) Physical Cues—all other cues which most commonly include the use of color, lettering style, texture, icons, shape, and names which utilize an adjective commonly used to describe a personality. When bundled with objective or Abstract Lifestyle/Personality Cues, Physical Cues can enhance the communication. They play a key role in the consumer's recognition of a particular classification at purchase decisions subsequent to the first purchase decision.

In one particularly preferred embodiment, the consumer is presented with two Objective Cues, a roast scale and a coffee guide, as described herein below. The coffee guide is primarily an Objective Cue using short descriptions of at least two classifications to describe both the degree of roast and the flavor character for the consumer. However, it also incorporates Physical Cues through the use of color and product names.

In one particularly preferred embodiment of the present invention, at least two cues, preferably more than two, are used, including at least one Abstract Lifestyle/Personality Cue where the Abstract Lifestyle/Personality Cue is an Object or Prop which remains constant across all classifications but varies in shape or style across at least three classifications. The Abstract Lifestyle/Personality Cue is at least one prop or object used to ascribe a character to each classification, such as a sun or a coffee cup/mug which varies in shape or style across a minimum of three classifications.

In another particularly preferred embodiment of the present invention, at least one Non-Coffee Related Objective Cue is used and at least one Abstract Lifestyle/Personality Cue per classification where the Abstract Lifestyle/Personality Cue is an Object or Prop is unique for each of three or more classifications. One example of this type of embodiment would be the use of a vase used to represent one classification, a violin used to represent a second classification, and a suitcase used to represent a third classification.

In another particularly preferred embodiment of the present invention, at least two cues are used. At least two of these cues are Non-Coffee Related Objects or Props (Abstract Lifestyle/Personality Cues) which vary across at least three classifications in shape or are unique across three or more classifications. One example of this type of embodiment would be the use of a vase and flowers to represent one of the two classifications and the use of a violin and a piano to represent the second classification. Another example of this type of embodiment would be the use of a vase or mug to represent one classification and the use of a violin or a different shape mug to represent the second classification.

In another particularly preferred embodiment of the present invention, at least three cues are used. At least two of these cues are Non-Coffee Related Objects or Props (Abstract Lifestyle/Personality Cues) which vary across at least two classifications in shape or are unique across two or more classifications. The third cue is a coffee related accessory which varies across at least two classifications in shape or is unique across two or more classifications. One example of this type of embodiment would be the use of a cup or mug which varies in shape or style across at least two classification plus the use of a vase and flowers to represent one of the two classifications and the use of a violin and a piano to represent the second classification.

As used herein the term “coffee products” may refer to whole bean, ground, instant or a formulated coffee beverage. The product may be prepared by the consumer or available in a ready-to-drink form. Multiple samples of the same variety of coffee are considered one coffee product. It is not necessary that the beverage actually be brewed for coffee grinds, whole beans, or instant granules to be considered “coffee” within the meaning of this specification.

Coffee products might differ from each other by virtue of differences in the underlying bean blend, by differences in the roasting process, or by both of these. For example a coffee consisting of 100% Colombian beans is a different coffee product than a coffee consisting of a blend of 50% Colombian beans and 50% Mexican beans. This is the case whether the beans have been subjected to the same or different roasting process. Likewise, a first coffee product might consist of a given blend of beans which have been roasted to yield a Hunter color of 17 L (according to the Hunter Colorimeter method, described below). A second coffee product might be made from the same supply of beans, but which has been roasted to yield a Hunter color of 14 L according to the Hunter Colorimeter method, described below. Of course, it is possible to vary both the underlying bean selection and the roasting parameters to yield a wide variety of coffee products

It has been found during development of the present invention that certain cues may be used to assist that consumer in the selection of coffee products from an available group or line-up. When such assistance is provided, it has been found that the acceptance of such products is statistically greater than if the consumer self-selected coffee products from the same available group without the benefit of the cues. The method mandates the ability to identify and provide coffee products relevant to two or more classifications, each providing a product with a different flavor profile. The present invention centers around the ability to effectively communicate these different flavor profiles to consumers such that they can identify an acceptable classification containing a coffee product or products they will like.

The term “classification” as used herein refers to one or more coffee products which are related by similar taste parameters or characteristics such as degree of roast and flavor character. Degree of roast is primarily a function of the roasting process to which a particular bean or blend of bean has been subjected. Degree of roast is preferably measured by the roast color of a particular coffee product. However, due to variation of blend and/or roasting process, the consumer's or an expert's impression of the degree of roast may vary somewhat from the Hunter L-Color measurement. It is preferable to use perception of degree of roast based on the finished product when communicating degree of roast information to the consumer. The Hunter “L” scale system is generally used to define the color of the coffee beans and the degree to which they have been roasted. Hunter Color “L” scale values are units of light reflectance measurement, and the higher the value is, the lighter the color is since a lighter colored material reflects more light. Thus, in measuring degrees of roast, the lower the “L” scale value the greater the degree of roast, since the greater the degree of roast, the darker is the color of the roasted bean. This roast color is usually measured on the coffee beans after they have been ground or flaked into a finished coffee product.

### Methods of the Present Invention

The method herein utilizes self-characterization cues to allow the consumer to view the cues at the point of purchase and then select the type of coffee represented by the cues that the consumer thinks most accurately describes the consumer's desired coffee experience. Among 241 coffee-drinking consumers asked to select a coffee from the lineup shown in FIG. 5, and then identify from five options, which cues were the most helpful, it was discovered that consumers rely on different cues to make their purchase decision and most use multiple cues to make their decision, making the bundling of multiple cues critical to success of the self-characterization system. The five cues the consumer selected among were roast scale, coffee guide, name, artwork, and color. 30% of consumers identified the name as the most helpful cue, 29% identified the roast scale as the most helpful cue, and 25% identified the coffee guide as the most helpful cue. The consumer is more consciously aware that he is using these more obvious objective and Physical Cues in the decision process. Nonetheless, 37% of consumers reported that artwork was among the three most helpful cues and 45% reported that color was among the three most helpful cues.

In a preferred embodiment, the number of available classifications in a given lineup of coffee products is two to eight, inclusive, more preferably 6. A plurality of different coffee products within one of the available classifications may be packaged in a common package.

It has been found during development of the present invention that certain key pieces of information regarding the taste preferences of a particular individual may be used to assist that individual in the selection of a classification of coffee products which are particularly adapted to the consumer's true taste preferences. The use of coffee products within such an adapted classification will preferably achieve a measurable increase in the acceptance of such products by consumers as compared to self-selection without assistance of the present method.

In one preferred embodiment of the present invention, there are six predetermined available coffee product classifications which correspond to particular ranges of taste preferences. Each range of taste preference characteristics has at least one corresponding classification of coffee products which is specifically adapted for acceptance by consumers within that range. An individual consumer selects the classification he feels will best provide his desired flavor.

Table 1 is a table which shows six possible classifications of coffee products which may be used in one embodiment of carrying out the method of the present invention.

As shown in Table 1, multiple cues, including a roast scale (Objective Cue) and artwork (Abstract Lifestyle/Personality Cues), and color (Physical Cue), are used to communicate the product flavor to the consumer. These cues are used to communicate both the degree of roast and the flavor character. In Table 1, flavor character is shown on the “Y”-axis, ranging from a balanced character to a unique or complex character. Degree of roast is shown on the “X”-axis, ranging from light to dark. The result is a two-dimensional plot that is difficult to communicate to the consumer without the use of cues which allow the consumer to easily characterize the flavor of the coffee product or classification.

In the embodiment of the method of the present invention described with the aid of Table 1, six total classifications are available.

TABLE 1
(X-Axis is Light Roast on the Left to Dark Roast on the Right.
Y-Axis is Balanced flavor on the Bottom to Complex Flavor on the Top)

| | | | |
|---|---|---|---|
| Classification 1 | Classification 3 | | |
| | | Classification 5 | Classification 6 |
| Classification 2 | Classification 4 | | |

The number of classifications may vary, although a total of 2 to 8 classifications are preferred. High numbers of classifications tend to over-segment the population and may increase the complexity and manageability of using the system without obtaining much additional benefit with respect to consumer acceptance. If the number of available classifications is too few, not enough differentiation will be achieved, leading to a decrease in overall acceptance of the method. The classifications shown in Table 1, may be expanded or reduced by combining some of the shown classifications or splitting some of those shown into two or more.

Preferably, when combining classes together, those which are expected to represent smaller percentages of the overall coffee drinking population and represent similar flavor preferences, should be combined. Similarly, classifications which are expected to represent larger percentages of the overall coffee drinking population may be good candidates for additional segmentation.

While particular embodiments of the present invention have been illustrated and described, it would be readily understandable to those skilled in the art that various other changes and modifications can be made without departing from the spirit and scope of the invention. Any of the aspects of the invention of the present method found to offer advantages over the state of the art may be used separately or in any suitable combination to achieve some or all of the benefits of the invention disclosed herein.

What is claimed is:

1. A method for directing a consumer to one or more types of coffee from a plurality of options, said method comprising the steps of:
presenting Multiple Self-Characterization Cues to said consumer regarding said consumer's coffee taste preferences, said information collection being provided through the use of a representation at the point of purchase;
said representation describing a classification of coffee products from among at least two available classifications, each of which may contain multiple coffee products, wherein each of said available classifications corresponds to a predetermined range of coffee taste preferences; and
said Multiple Self-Characterization Cues comprising one Abstract Lifestyle/Personality Cue which is the same object across three or more classifications but varies in shape, thereby allowing the consumer to identify and purchase one or more of said products.

2. The method according to claim 1 wherein there are multiple products contained within each available classification.

3. The method of claim 1 wherein the Self-Characterization Cues comprise additionally at least two self-characterization cues selected from the following:
a) at least one Objective Cue providing informative, coffee-related data;
b) at least one Abstract Lifestyle/Personality Cue utilizing depictions of physical objects or props that vary among at least two classifications; and
c) optionally, one or more Physical Cues, that vary among at least two classifications.

4. The method of claim 1 wherein the Self-Characterization Cues additionally comprise at least two self-characterization cues selected from the following:
a) at least two Objective Cues;
b) optionally, one or more Abstract Lifestyle/Personality Cues that vary among at least two classifications; and
c) optionally, one or more Physical Cues.

5. The method of claim 2 wherein the Self-Characterization Cues additionally comprise a roast scale.

6. The method of claim 2 wherein the Self-Characterization Cues additionally comprise a coffee guide.

7. The method of claim 2 wherein said method additionally comprises at least two Abstract Lifestyle/Personality Cues, at least one of which Non-Coffee Related Abstract Lifestyle/Personality Cue.

8. The method of claim 2 wherein said method additionally comprises at least two Abstract Lifestyle/Personality Cues.

9. The method of claim 2 wherein the Abstract Lifestyle/Personality Cue is a coffee cup or mug that varies across at least two classifications.

10. The method of claim 3 wherein the Objective Cues are a roast scale and a coffee chart/guide.

11. The method of claim 8 wherein at least one Non-Coffee Related Abstract Lifestyle/Personality Cue is used.

12. The method of claim 11 wherein the said Non-Coffee Related Abstract Lifestyle/Personality Cue is a depiction of an Object or Prop representing a clothing accessory.

13. The method of claim 11 wherein the said Non-Coffee Related Abstract Lifestyle/Personality Cue is a depiction of an Object or Prop representing a business accessory.

14. The method of claim 11 wherein the said Non-Coffee Related Abstract Lifestyle/Personality Cue is a depiction of an Object or Prop representing a home decorative item.

15. The method of claim 1 wherein said representation is fixedly mounted to a shelf display unit.

16. The method of claim 1 wherein said representation comprises a modified slide-rule type device.

17. The method of claim 1 wherein said representation comprises a printed chart and accompanying instructions for use.

18. The method of claim 1 wherein said representation comprises an interactive computer.

19. The method of claim 1 wherein said representation is on product packaging.

20. A method for directing a consumer to one or more types of coffee from a plurality of options, said method comprising the steps of:
presenting Multiple Self-Characterization Cues to said consumer regarding said consumer's coffee taste preferences, said information collection being provided through the use of a representation at the point of purchase;
said representation describing a classification of coffee products from among at least two available classifications, each of which may contain multiple coffee products, wherein each of said available classifications corresponds to a predetermined range of coffee taste preferences; and
said Multiple Self-Characterization Cues comprising one Non-Coffee Related Abstract Lifestyle/Personality Cue which a unique object across three or more classifications, thereby allowing the consumer to identify and purchase one or more of said products.

21. The method according to claim 20 wherein there are multiple products within each available classification.

22. The method of claim 20 wherein the Self-Characterization Cues comprise at least two Self-Characterization Cues selected from the following:
a) at least one Objective Cue providing informative, coffee-related data;
b) at least one Abstract Lifestyle/Personality Cue utilizing depictions of physical objects or props that vary among at least two classifications; and
c) optionally, one or more Physical Cues, that vary among at least two classifications.

23. The method of claim 20 wherein the Self-Characterization Cues additionally comprise at least two self-characterization cues selected from the following:
a) at least two Objective Cues;
b) optionally, one or more Abstract Lifestyle/Personality Cues that vary among at least two classifications; and
c) optionally, one or more Physical Cues.

24. The method of claim 22 wherein the Self-Characterization Cues additionally comprise a roast scale.

25. The method of claim 22 wherein the Self-Characterization Cues additionally comprise a coffee guide.

26. The method of claim 22 wherein said method additionally comprises at least two Abstract Lifestyle/Personality Cues.

27. The method of claim 22 wherein the Abstract Lifestyle/Personality Cue is a coffee cup or mug that varies across at least two classifications.

28. The method of claim 23 wherein the Objective Cues are a roast scale and a coffee chart/guide.

29. The method of claim 28 wherein at least one additional Non-Coffee Related Abstract Lifestyle/Personality Cue is used.

30. The method of claim 29 wherein the said Non-Coffee Related Abstract Lifestyle/Personality Cue is a coffee cup or mug.

31. The method of claim 20 wherein said representation is fixedly mounted to a shelf display unit.

32. The method of claim 20 wherein said representation comprises a modified slide-rule type device.

33. The method of claim 20 wherein said representation comprises a printed chart and accompanying instructions for use.

34. The method of claim 20 wherein said representation comprises an interactive computer.

35. The method of claim 20 wherein said representative is on product packaging.

36. A method for directing a consumer to one or more types of coffee from a plurality of options, said method comprising the steps of:
presenting Multiple Self-Characterization Cues to said consumer regarding said consumer's coffee taste preferences, said information collection being provided through the use of a representation at the point of purchase;
said representation describing a classification of coffee products from among at least two available classifications, each of which may contain multiple coffee products, wherein each of said available classifications corresponds to a predetermined range of coffee taste preferences; and
said Multiple Self-Characterization Cues comprising at least two Objective Cues, thereby allowing the consumer to identify and purchase one or more of said products; wherein

37. The method according to claim 36 wherein there are multiple products contained within each available classification.

38. The method of claim 36 wherein the Self-Characterization Cues comprise at least three self-characterization cues selected from the following:
a) at least two Objective Cues providing informative, coffee-related data;
b) at least one Abstract Lifestyle/Personality Cue utilizing depictions of physical objects or props that vary among at least two classifications; and
c) optionally, one or more Physical Cues that vary among at least two classifications.

39. The method of claim 36 wherein the Self-Characterization Cues comprise in addition to at least two Objective Cues, at least two self-characterization cues selected from the following:
a) Two or more Abstract Lifestyle/Personality Cues that vary among at least two classifications; and
b) optionally, one or more Physical Cues.

40. The method of claim 38 wherein the Self-Characterization Cues comprise:
a) a roast scale;
b) at least one Non-Coffee Related Abstract Lifestyle/Personality Cue.

41. The method of claim 38 wherein the Self-Characterization Cues comprise:
a) a coffee guide;
b) at least one Non-Coffee Related Abstract Lifestyle/Personality Cue.

42. The method of claim 38 wherein said method comprises at least three Abstract Lifestyle/Personality Cues.

43. The method of claim 38 wherein one Abstract Lifestyle/Personality Cue is a coffee cup or mug that varies across at least two classifications.

44. The method of claim 36 wherein the Objective Cues are a roast scale and a coffee chart/guide.

45. The method of claim 44 wherein at least one Abstract Lifestyle/Personality Cue is used.

46. The method of claim 45 wherein said Abstract Lifestyle/Personality Cue is a coffee cup or mug.

47. The method of claim 46 wherein said Abstract Lifestyle/Personality Cue comprises, in addition to the coffee cup or mug, a Non-Coffee Related Abstract Lifestyle/Personality Cue.

48. The method of claim 36 wherein said representation is fixedly mounted to a shelf display unit.

49. The method of claim 36 wherein said representation comprises a modified slide-rule type device.

50. The method of claim 36 wherein said representation comprises a printed chart and accompanying instructions for use.

51. The method of claim 36 wherein said representation comprises an interactive computer.

52. The method of claim 36 wherein said representation is on packaging.

53. A method for directing a consumer to one or more types of coffee from a plurality of options, said method comprising the steps of:
presenting two or more Non-Coffee Related Multiple Self-Characterization Cues to said consumer regarding said consumer's coffee taste preferences, said information collection being provided through the use of a representation at the point of purchase;
said representation describing a classification of coffee products from among at least three available classifications, each of which may contain multiple coffee products, wherein each of said available classifications corresponds to a predetermined range of coffee taste preferences, thereby allowing the consumer to identify and purchase one or more of said products.

54. The method according to claim 53 wherein there are multiple products within each available classification.

55. The method of claim 53 wherein the Self-Characterization Cues additionally comprise at least two self-characterization cues selected from the following:
a) at least one Objective Cue providing informative, coffee-related data;
b) at least one Abstract Lifestyle/Personality Cue utilizing depictions of physical objects or props that vary among at least two classifications; and
c) optionally, one or more Physical Cues, that vary among at least two classifications.

56. The method of claim 53 wherein the self-characterization cues additionally comprise at least two self-characterization cues selected from the following:
a) at least two Objective Cues;
b) optionally, one or more Abstract Lifestyle/Personality Cues that vary among at least two classifications; and
c) optionally, one or more Physical Cues.

57. The method of claim 55 wherein the Self-Characterization Cues additionally comprise a roast scale.

58. The method of claim 55 wherein the Self-Characterization Cues additionally comprise a coffee guide.

59. The method of claim 55 wherein said method additionally comprises at one Abstract Lifestyle/Personality Cue that is Coffee Related.

60. The method of claim 59 wherein the Abstract Lifestyle/Personality Cue is a coffee cup or mug that varies across at least two classifications.

61. The method of claim 56 wherein the Objective Cues are a roast scale and a coffee chart/guide.

62. The method of claim 61 wherein at least one Abstract Lifestyle/Personality Cue is used.

63. The method of claim 61 wherein said Abstract Lifestyle/Personality Cue is a coffee cup or mug.

64. The method of claim 53 wherein said representation is fixedly mounted to a shelf display unit.

65. The method of claim 53 wherein said representation comprises a modified slide-rule type device.

66. The method of claim 53 wherein said representation comprises a printed chart and accompanying instructions for use.

67. The method of claim 53 wherein said representation comprises an interactive computer.

68. The method of claim 53 wherein said representation is on product packaging.
